(19) United States
(12) Patent Application Publication
(10) Pub. No.: US 2007/0010220 A1
(43) Pub. Date: Jan. 11, 2007

(54) Mobile FM emitter with wireless remote controlling functions

(76) Inventor: Vincent Lai, Taoyuan Hsien (TW)

Correspondence Address: PRO-TECHTOR INTERNATIONAL SERVICES, 20775 NORADA CT., SARATOGA, CA, 95070, US

(21) Appl. No.: 11/177,911

(22) Filed: Jul. 7, 2005

(51) Int. Cl. H04B 1/00

(52) U.S. Cl. 455/142; 455/130

(57) ABSTRACT

A mobile FM emitter with wireless remote controlling functions and decoding functions for MP3/WMA files includes a wireless remote controller and a built-in USB connecter. The power is supplied by a 12V cigarette lighter plug. Through wireless remote controlling, the users can select songs of an externally connected MP3 portable storage device/player and control the volume.

### BACKGROUND OF THE INVENTION

(a) Field of the Invention

The invention relates to a mobile FM emitter, and more particularly to a mobile FM emitter with decoding capability for MP3 and WMA files comprising a built-in USB connector and a wireless remote control. The wireless remote control enables song selection and volume control when the mobile FM emitter is externally connected to a MP3 portable storage device/player, and the power thereof is supplied by a 12V mobile cigarette lighter.

(b) Description of the Prior Art

The mobile FM emitters with MP3 decoding function on the market does not include wireless remote controlling functions which is inconvenient to passengers in the car. In particularly, the location of the 12V cigarette lighters is low; pressing the buttons thereon would increase the probability of car accidents.

### SUMMARY OF THE INVENTION

The primary object of the invention is to provide a mobile FM emitter including a built-in USD connector and decoding function for MP3 and WMA files. Through a chip-decoding converter, the mobile FM emitter converts the MP3 format files of portable MP3 portable storage devices/players to the FM signals and radiates to a FM radio station receiver. The users can select the songs of external connected MP3 portable storage devices/players and control the volume with a wireless remote controller.

The MP3 digital music has became more and more popular. The successful marketing of Apple iPod encouraged the fourth revolution of music players. From the phonograph record players in the beginning to the cassette tape players, the CD players and eventually the portable MP3 players, the household stereo systems are shifting from CD players to the portable storage devices equipped with the USB connecters and MP3 decoding functions.

Due to the increase of automobiles, drivers' demand for portable music has increased as well. The fourth revolution of portable music players will change people's lifestyle in-door, out-door and in-car. The purpose of the invention is to enable the enormous automobile users to enjoy the diversity and convenience of the MP3 music through the original car stereo systems in coordination with the USB portable storage devices with the functions of wireless song selection and volume control on the premise of not having to remodel the car stereo systems despite their cars are new or old.

### DETAILED DESCRIPTION OF THE PREFERRED EMBODIMENTS

As shown in FIG. 1, a MP3 digital FM player is consisted of a mobile FM emitter 101 and a wireless remote controller 100. A built-in USB connecter 1011 of the mobile FM emitter 101 can externally connect to a USB MP3 player 102; the other side of the mobile FM emitter 101 can connect to a mobile 12V cigarette lighter plug 103 to supply power thereof. Referring to FIG. 2, a decoding chip 1012 for MP3 and WMA files is embedded in the mobile FM emitter 101 with the song selection and volume control functions. Furthermore, a embedded wireless decoding chip 1013 and a wireless encoder of the wireless remote controller 100 convert MP3 format files of the MP3 players to FM signals and radiate to a FM radio station receiver on a normal car stereo system 104 by infrared remote controlling via a MP3/WMA decoding chip 1012. Users can select songs or control the volume of the MP3 players by the wireless remote controller 100.

In conclusion, the invention is a mobile FM emitter with a built-in USB connecter and decoding functions for MP3 and WMA files.

### BRIEF DESCRIPTION OF THE DRAWINGS

FIG. 1 shows an elevational view according to the invention.

FIG. 2 shows a block diagram of a mobile FM emitter and a wireless remote control according to the invention.

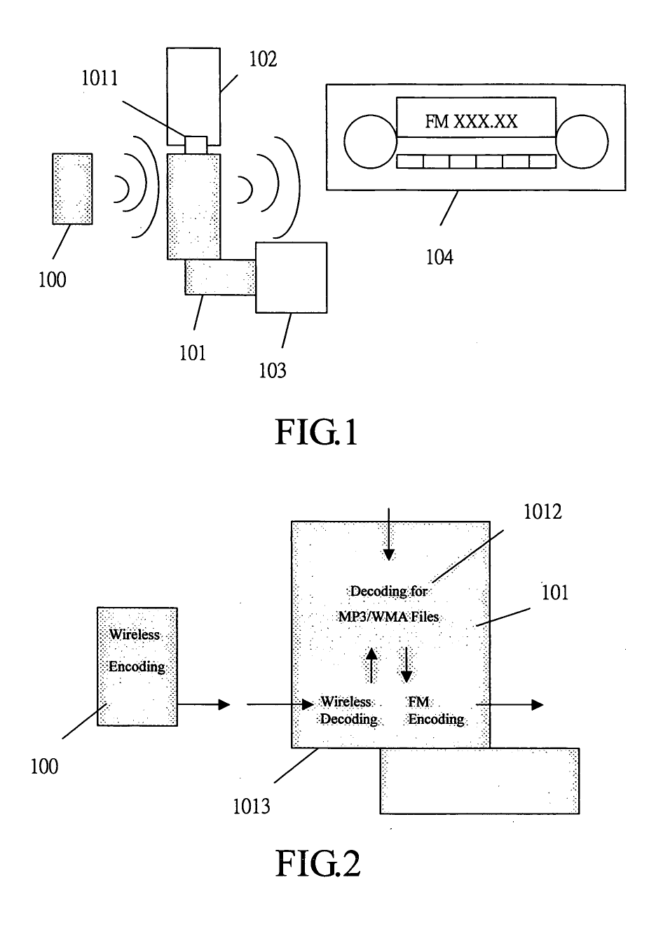

What is claimed is:

1. A mobile FM emitter with wireless remote controlling functions comprising:
a FM emitter with a embedded MP3/WMA decoding chip and a embedded wireless decoding chip that can externally connect to a USB portable storage device or a MP3 player on one side and a mobile 12V cigarette lighter plug on the other side;
a wireless remote controller that enables song selection and volume control, converts MP3 format files in a MP3 portable storage device/player to FM signals through the MP3/WMA decoding chip by remote controlling and radiates the FM signals to a FM station receiver on a car stereo system.

2. The mobile FM emitter with wireless remote controlling functions in accordance with claim 1, wherein the wireless remote controller is an infrared wireless remote control.
